(19) United States
(12) Patent Application Publication
(10) Pub. No.: US 2007/0208731 A1
(43) Pub. Date: Sep. 6, 2007

(54) Document information processing apparatus, method of document information processing, computer readable medium and computer data signal

(75) Inventors: Noriji Kato, Kanagawa (JP); Takashi Isozaki, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/546,980

(22) Filed: Oct. 13, 2006

(30) Foreign Application Priority Data
Mar. 6, 2006 (JP) 2006-060079

(51) Int. Cl. G06F 17/30

(52) U.S. Cl. 707/5

(57) ABSTRACT

A document information processing apparatus includes: a retention unit that retains attention probability weight corresponding to a plurality of factor information for each users; a selection unit that selects a document, the document being inferred to be paid attention to, from a document group by using the attention probability weight of the plurality of the factor information; and a presentation unit that presents information corresponding to at least one of the plurality of the factor information used by the selection unit.

### BACKGROUND

1. Technical Field

This invention relates to a document information processing apparatus for estimating the attention degree for each user about the processed document.

2. Related Art

In recent years, document management using a computer has become widespread and the number of documents viewed by the user has also increased. Under the circumstances, an art of searching for the document to which the user should pay attention is demanded.

### SUMMARY

It is therefore an object of the invention to provide a document information processing apparatus that can analyze the factor for the user to pay attention to a document from various factors not only a limited keyword.

According to first aspect of the invention, a document information processing apparatus comprising: a retention unit that retains attention probability weight corresponding to a plurality of factor information for each users; a selection unit that selects a document, the document being inferred to be paid attention to, from a document group by using the attention probability weight of the plurality of the factor information; and a presentation unit that presents information corresponding to at least one of the plurality of the factor information used by the selection unit.

### BRIEF DESCRIPTION OF THE DRAWINGS

Exemplary embodiment of the present invention will be described in detail based on the following figures, wherein:

FIG. 1 is a block diagram to show the configuration of an example of a document information processing apparatus according to an embodiment of the invention;

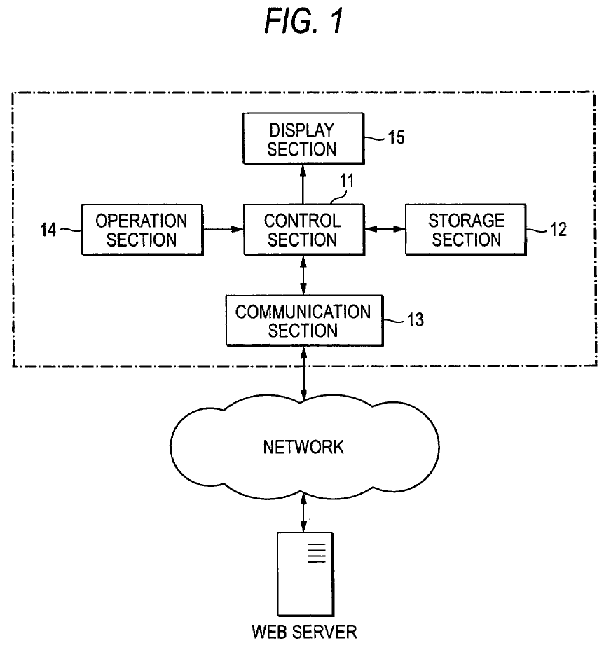

FIG. 2 is a functional block diagram to show an example of the document information processing apparatus according to the embodiment of the invention;

FIG. 3 is a conceptual drawing to show an example of a Bayesian network generated and used by the document information processing apparatus according to the embodiment of the invention; and

FIG. 4 is a schematic representation to show an example of attention probability weight for each piece of factor information retained for each user by the document information processing apparatus according to the embodiment of the invention.

### DETAILED DESCRIPTION

Referring now to the accompanying drawings, there is shown an exemplary embodiment of the invention. A document information processing apparatus according to the embodiment of the invention is made up of a control section 11, a storage section 12, a communication section 13, an operation section 14, and a display section 15.

The control section 11 is a program control device of a CPU, etc., and operates in accordance with a program stored in the storage section 12. In the embodiment, the control section 11 authenticates the user and retains a history of manipulations on a document for each authenticated user. The manipulation history includes read (view) operation, print operation, deletion operation, etc., for example, and also retains information of the operation execution dates and times. The control section 11 generates information of attention probability weight for each user (called user profile information) for factor information that can be extracted from the manipulated document (profiling processing).

Further, the control section 11 uses the user profile information based on the factor information to select the document estimated to be noted from among the processed documents, and presents information for determining the factor information about at least a part of the used factor information to the user (factor presentation processing). The profiling processing and the factor presentation processing of the control section 11 are described later in detail.

The storage section 12 is implemented including a storage device of RAM, ROM, etc., and a disk device of a hard disk, etc. The storage section 12 retains programs executed by the control section 11. The storage section 12 also operates as work memory of the control section 11. The communication section 13 is a network interface, etc., for acquiring a document through a network in accordance with a command input from the control section 11 and storing the document in the storage section 12.

The operation section 14 is a keyboard, a mouse, etc., and receives user operation and outputs the description of the command operation to the control section 11. The display section 15 is a display, etc., and displays information in accordance with the command input from the control section 11.

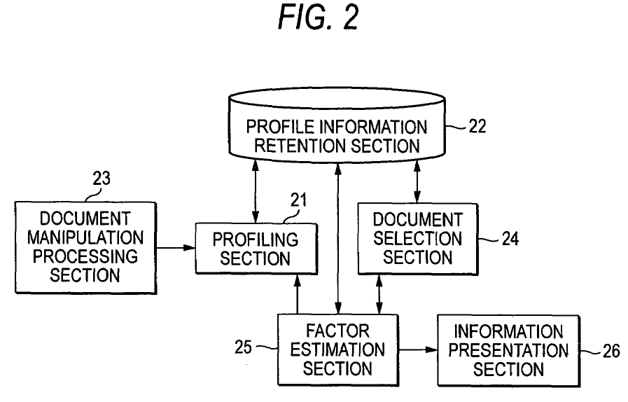

The document information processing apparatus of the embodiment provides functions as shown in FIG. 2 by software as the control section 11 executes profiling processing and attention degree computation processing. That is, the document information processing apparatus of the embodiment is functionally made up of a profiling section 21, a profile information retention section 22, a document manipulation processing section 23, a document selection section 24, a factor estimation section 25, and an information presentation section 26, as shown in FIG. 2.

It is assumed that the control section 11 previously authenticates the user and obtains information for identifying the user. For authentication, various methods such as a method of using a user name and a password are available as widely known and therefore the authentication will not be discussed here in detail.

The profiling section 21 forms a Bayesian network containing each piece of factor information selected from among predetermined factor information candidates as a node. The Bayesian network contains a node concerning the description of command operation of the user and a node indicting that the target document is to be noted by the user.

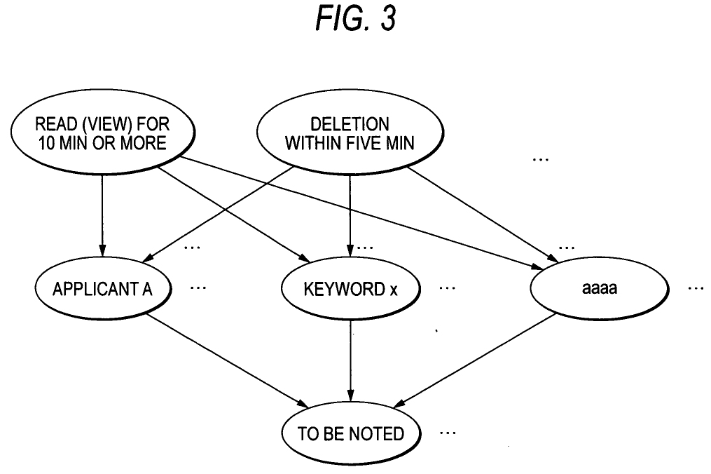

The Bayesian network becomes conceptually a network as shown in FIG. 3. Information of attention probability weight is set in each node of factor information in association with each other. For example, if the target document is a patent document, keyword information extracted from the document, applicant information contained in bibliographic information, classification information of international patent classification value and others, the inventor name, etc., can be adopted as factor information candidates.

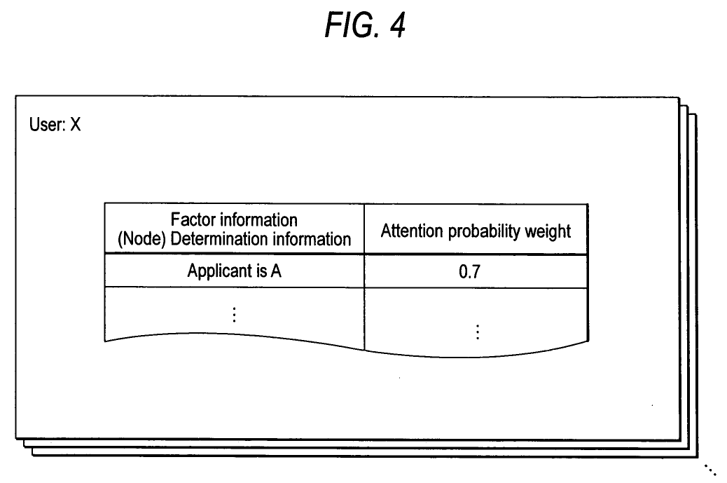

The profile information retention section 22 retains for each user a profile database associating information for identifying the node of factor information (a character string describing the factor information, for example, “applicant is A” or the like) and information of attention probability weight in association with each other as shown in FIG. 4.

Upon reception of the description of the command operation of the user for a document from the document manipulation processing section 23, the profiling section 21 extracts factor information concerning the document to be manipulated and changes the attention probability weight of the node corresponding to the extracted factor information, stored in the profile information retention section 22 in association with the information for identifying the user.

For example, if the information output by the document manipulation processing section 23 contains the user's read (view) start date and time and end date and time, the profiling section 21 calculates the read (view) time of the user from the information. It extracts the factor information corresponding to the node contained in the Bayesian network from the read (viewed) document. For example, the profiling section 21 extracts keyword, classification information, etc. On the hypothesis that the longer the read (view) time, the higher the attention probability, the profiling section 21 increases the attention probability weight of the node corresponding to the extracted factor information according to a predetermined method. To increase the attention probability weight, various methods of a method of increasing the attention probability weight at a given ratio, a method of increasing the attention probability weight by the amount responsive to the read (view) time, for example, are available. For example, a method widely known as a method of estimating the importance of electronic mail, etc., can be adopted as the method of updating the Bayesian network in response to user's operation.

For example, the document manipulation processing section 23 acquires document data through the network in response to user's command operation and displays the document data on the display section 15. Upon reception of input of user's command operation for the document (read (view) start command, read (view) end command, deletion command, etc.,), the document manipulation processing section 23 outputs information indicating the command operation to the profiling section 21 together with the date and time information indicating the date and time of the command operation. The date and time information can be acquired from a calendar IC, etc., (not shown).

The document selection section 24 acquires a document group to which processing is applied from the network or a predetermined document database at a predetermined timing such as the timing specified by the user. For example, a predetermined number of documents stored in a predetermined URL (Uniform Resource Locator) in order starting at the newest storage date and time may be acquired. All documents stored in the document database (not shown) may be acquired as processing targets.

The document selection section 24 extracts the factor information corresponding to the node contained in the Bayesian network formed by the profiling section 21 from each of the documents acquired as the processing targets. It calculates the probability that each document is a document to be noted (attention probability) using the information of the attention probability weight associated with the extracted factor information. The document selection section 24 selects the document with the probability exceeding a predetermined threshold value as the selected document and stores the selected document in the storage section 12. The calculation of the probability that each document is a document to be noted is similar to the calculation of the importance using a usual Bayesian network and therefore will not be discussed here in detail.

The factor estimation section 25 selects at least a part of the factor information used for the document selection in the document selection section 24 satisfying a predetermined condition and outputs the information for determining the selected factor information to the information presentation section 26.

Using Bayes' theorem, about the value of the attention probability calculated based on the attention probability weight of each piece of factor information when the selected document is determined a document to be noted, the probability of the factor information used when the selected document is determined a document to be noted is calculated inversely from the value of the attention probability. That is, the Bayes' theorem associates the probability of B when A and the probability of A when B with each other and therefore the cause and effect relationship is inversed and the probability that each piece of factor information may be used for document selection can be calculated from the document selection probability.

For each selected document, the factor estimation section 25 calculates the probability that each piece of factor information may be used for selection of the document. The factor estimation section 25 selects as many pieces of factor information as the predetermined number of presentations in order starting at that with the highest probability and outputs the information for determining the selected factor information (a character string describing the factor information or the like) to the information presentation section 26.

The information presentation section 26 lists the information for determining the factor information input from the factor estimation section 25 on the display section 15. At this time, the documents selected by the document selection section 24 may also be listed on the display section 15.

If factor information candidates which do not become factor information are common to the document group selected by the document selection section 24 (corresponding to addition criterion) at a predetermined ratio or more, the factor estimation section 25 may send the factor information candidates to the profiling section 21 as the addition targets.

In this case, the profiling section 21 adds the nodes corresponding to the factor information candidates sent as the addition targets to the Bayesian network and initializes the information of the attention probability weight (for example, to 1).

According to the embodiment, if the user reads (views) a patent document whose applicant is A for long hours without concern, the attention probability weight relating to the node that “applicant is A” in the Bayesian network is raised and the document whose “applicant is A” is selected as the document to be noted. Inversely from the selection result, the node that “applicant is A” is selected as the node with high probability of use for document selection and the factor information that “applicant is A” representing the node is presented to the user.

Accordingly, it is made possible for the user to know the attention factor of the document not in mind. In the embodiment, using the Bayesian network, as the information that can be extracted from documents, not only the keywords, but also various pieces of factor information containing the keywords can be contained as the nodes in the Bayesian network. Thus, the factors when the user pays attention to a document can be analyzed from various factors containing the keywords.

What is claimed is:

1. A document information processing apparatus comprising:
a retention unit that retains attention probability weight corresponding to a plurality of factor information for each users;
a selection unit that selects a document, the document being inferred to be paid attention to, from a document group by using the attention probability weight of the plurality of the factor information; and
a presentation unit that presents information corresponding to at least one of the plurality of the factor information used by the selection unit.

2. The document information processing apparatus as claimed in claim 1, which comprises:
an addition determination unit that selects factor information from the factor information candidate based on a predetermined addition criterion, and that calculates the attention probability weight based on the factor information selected, and that retains the attention probability weight in the retention unit.

3. A method of document information processing comprising:
retaining attention probability weight corresponding to a plurality of factor information for each users;
selecting a document, the document being inferred to be paid attention to, from a document group by using the attention probability weight of the plurality of the factor information; and
presenting information corresponding to at least one of the plurality of the factor information.

4. A computer readable medium storing a program causing a computer to execute a process for estimating the attention degree for each user about a processed document, the process comprising:
retaining attention probability weight corresponding to a plurality of factor information for each users;
selecting a document, the document being inferred to be paid attention to, from a document group by using the attention probability weight of the plurality of the factor information; and
presenting information corresponding to at least one of the plurality of the factor information.

5. A computer data signal embodied in a carrier wave for enabling a computer to perform a process for estimating the attention degree for each user about a processed document, the process comprising:
retaining attention probability weight corresponding to a plurality of factor information for each users;
selecting a document, the document being inferred to be paid attention to, from a document group by using the attention probability weight of the plurality of the factor information; and
presenting information corresponding to at least one of the plurality of the factor information.
